(19) United States
(12) Patent Application Publication
(10) Pub. No.: US 2019/0066197 A1
(43) Pub. Date: Feb. 28, 2019

(54) System and Method for Clothing Promotion

(71) Applicant: Jing Zhang, Manhattan Beach, CA (US)

(72) Inventor: Jing Zhang, Manhattan Beach, CA (US)

(21) Appl. No.: 15/687,527

(22) Filed: Aug. 27, 2017

(51) Int. Cl. G06Q 30/06; G06Q 30/02; H04N 5/232; H04N 13/02

(52) U.S. Cl. CPC G06Q 30/0643; G06Q 30/0277; H04N 5/23238; H04N 5/2252; H04N 13/0282; H04N 2213/001; H04N 13/0203

(57) ABSTRACT

A clothing promotion system having virtue clothes fitting function, and evolving consumers in promotion. The clothing promotion system comprises a 360 degree image collecting apparatus collecting image data of clothing articles worn by models; an image processor processing the image data to generate 3D components; a database storing the image data and 3D components; and a plurality of interaction units interacting with the image processor and the database to select 3D components to create a 3D effect image, and displaying the created 3D effect image to illustrate the effect of the selected model wearing the selected clothing articles.

### BACKGROUND

### 1. Field of the Invention

The present invention relates to a clothing promotion system and method. More particularly, the method using virtual dressing technique to encourage customers to promote clothes.

### 2. Discussion of the Related Art

The apparel market is valued at several trillion dollars in the world, and is unavoidably highly competitive. Therefore marketing is very important in this industry. There are so many techniques and strategies involved in this field. But no matter what technique and strategy are used, modeling are always the most important element.

Models (real person) and mannequins (dummies) are widely used in apparel industry to display the dressing effect of the closes or ornaments. Referring to the visual effects from models, consumers can have a better chance to evaluate if the closes or ornaments are suitable for them to purchase. It is also the best way to promote and advertise those commercial products. When online shopping is getting more and more popular, using models to demonstrate the closes is becoming more important because customers usually don't have a chance to try the clothes and ornaments on before they make the purchase. Images of models dressing up with the clothes and ornaments can help the customers in front of the computer make a decision.

But there is always a problem for modeling. Each customer has a unique body. In order to adapt different body figures, the garment industry developed a complex sizing system with many standards for various garments, such as dresses, tops, skirts, and trousers. But for cost issue, usually only one model is employed to wear a particular piece of clothes, showing the result of one size. And for promotional purpose, only professional models who can display the best effects are selected to attract consumers. Their body figures can't reflect the normal customers' effects. Therefore, modeling may mislead the customers and eventually make the customers feel disappointed. This will cause a large rate of return. Also, there are so many online sellers whose reputations are not even. Pictures of clothes on models are very easy to be modified and may mislead the consumers by dishonest sellers.

Another problem is, there are literally unlimited possibilities of clothing collocation. Different tops pair with different pants, and different shoes can provide so different effects. But it is difficult to use models to display all possibilities.

Recent technologies enable online shoppers virtually try on the clothes through software simulation. Some systems enable people to visualize how clothes might look on them by taking into account their personal body measurements. It is not difficult now to simulate all different possibilities without real model. At this application, a virtual fitting requires the user to submit their measurements to create a representation. For example, 3D body scanner technology is employed. A 3D scanner can create a digital profile of customer's entire body to generate a 3D body model, combined with the customer's choice of fit, materials and features, to produce entirely bespoke items of clothing.

While 3D body scanner technology also has some disadvantages. It will take around 20 minutes to do a whole body scanning, and will generate a large amount of data. The scanner is expensive and in a large size which limit the installation. Finally, current 3D scanning technique still has difficulties in getting accurate details for some complex geometries and particular materials which are unavoidable for clothes.

Besides the limitation in technique, there are also problems in application. Theoretically these new technologies can generate visual images for all the possibilities of clothing collocation, but it will result in a huge amount of images and data. Practically people won't be able to review all these results. Then how to evaluate the effect of dressing combination becomes an issue, because it is a very subjective process, involving fashion trend, personal interests, cultural background, and many other human factors. Artificial intelligence still can't perform well in this area. Manufacturers and designers may recommend some collocations, but only using their own product lines. So the choices are very limited. Therefore human is still the only resource to perform the selection and promotion. Then the question is, facing the huge amount of work, how to reduce the cost in man power.

Considering all these issues mentioned above, it would be desirable to provide an apparatus and method to promote clothes.

### BRIEF SUMMARY OF THE INVENTION

The primary objective of the present invention is to develop a method and system for clothing promotion.

Another objective of the present invention is to develop a method and a system for clothing promotion for online shopping.

Another objective of the present invention is to develop a method and a system for clothing promotion for multiple brands and product lines.

Another objective of the present invention is to develop a method and a system for clothing promotion using a large number of models.

Another objective of the present invention is to develop a method and a system for clothing promotion with limited cost.

Another objective of the present invention is to develop a method and a system for clothing promotion reflecting the customer opinions directly.

In order to achieve the objectives, the present invention facilitates both the sellers/manufacturers and consumers to provide 3D effect images of the clothes worn by real persons. As a result, a large number of models with different body figures can be used to illustrate the clothes effects.

Also, the system enable ordinary consumers to participate in the promotion. Any person is able to be a model to try the promoted clothes. Therefore all different shapes and sizes can be presented, and the cost for modeling is very limited. Also any person is able to be a designer to pair different clothes, comment on other people's collocation, and recommend what he or she preferred. This will reflect the end user's interests and favor directly. Finally, with the popularization of internet, smart phone, and social media, any person is able to be a publisher to disclose the clothes or clothing collocation for promotion.

A 360 degree image collecting apparatus is developed to generate 3D effect image for a model, which comprises:

a camera taking pictures of the model;

a model platform which comprises a base board rested on the ground; and a stand board fixed over the base board supporting a model to stand thereon;

a rotate platform rotatablely rested over the base board and under the model platform, comprises a camera frame supporting the camera focusing on the model with a adjustable height and a predetermined focal length, wherein the rotate platform rotates the camera around the model over the stand board to take multiple pictures from different angles.

A clothing promotion system of the invention comprises:

a 360 degree image collecting apparatus collecting image data of a plurality of models' heads and a plurality of clothing articles worn by models, wherein the models could be consumers, professional models, or dummies;

an image processor processing the image data collected by the 360 degree image collecting apparatus and generating 3D components of the models' heads and the clothing articles wherein the 3D components can be displayed in 3D effect;

a database storing the image data and 3D components; and

a plurality of interaction units interacting with the image processor and the database to select 3D components of a model's head and one or more clothing articles to create a 3D effect image, and displaying the created 3D effect image to illustrate the effect of the selected model wearing the selected clothing articles.

A method of clothing promotion of the invention comprises the following steps, in whole or part:

collecting image data of each consumer;

generating a set of parameters to describe the body figures of the consumer and a 3D component of the head of the consumer using the image data collected from the consumer;

collecting image data of each scenario of each clothing article worn by a model, wherein the model could be a consumer, a professional model, or a dummy;

generating a set of parameters to describe the body figures of the model and a 3D component of the scenario of the clothing article using the image data;

storing the 3D component with its set of parameters;

selecting a 3D component of a consumer's head, and one or more 3D components of clothing articles to create a 3D effect image; and

displaying the 3D effect image to simulate the consumer wearing the selected clothing articles.

For a more complete understanding of the present invention with its objectives and distinctive features and advantages, reference is now made to the following specification and to the accompanying drawings.

### BRIEF DESCRIPTION OF THE DRAWINGS

FIG. 1 is a schematic view of the 360 degree image collecting apparatus of the present invention.

FIG. 2 is a perspective view of the 360 degree image collecting apparatus of the present invention.

FIG. 3 is a side view of the 360 degree image collecting apparatus of the present invention.

FIG. 4 is top view of the 360 degree image collecting apparatus of the present invention.

FIG. 5 is a schematic view of an alternative embodiment of the 360 degree image collecting apparatus of the present invention.

FIG. 6 is a schematic dialog of the clothing promotion system.

FIG. 7 illustrates a process for clothing promotion.

### DETAILED DESCRIPTION OF THE INVENTION

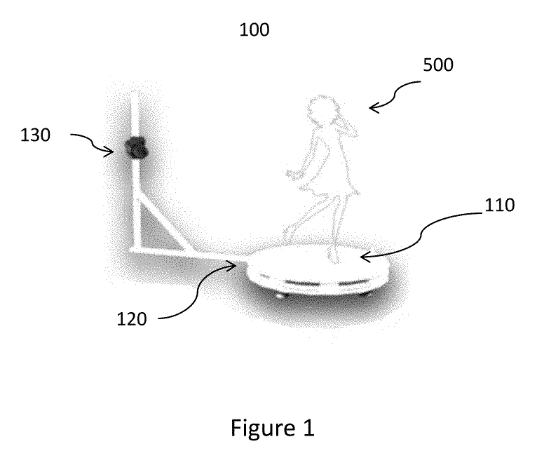

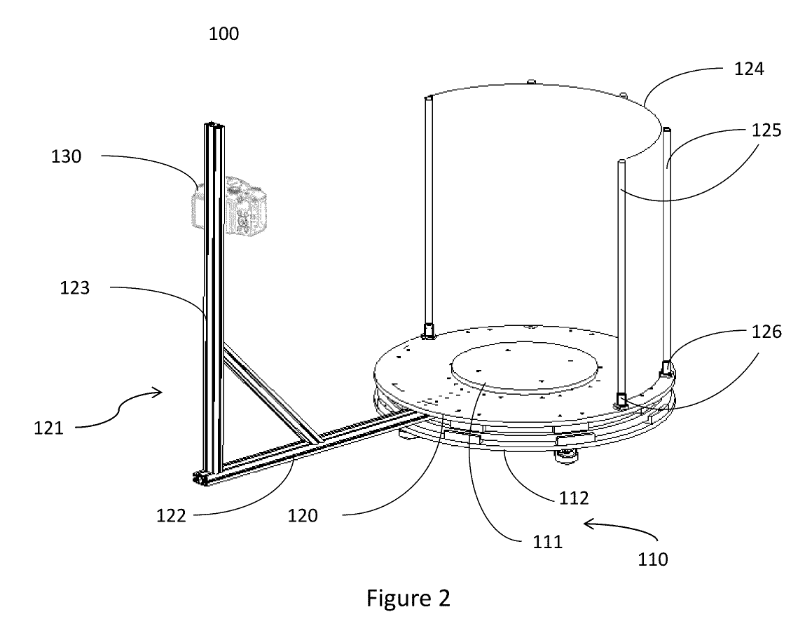

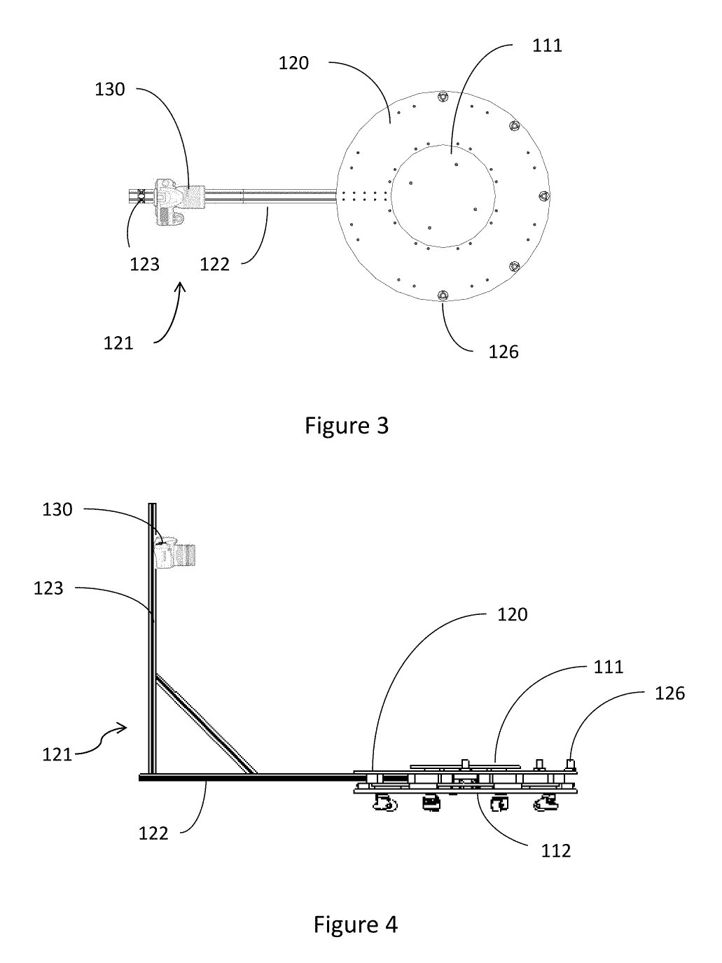

In accordance with a preferred embodiment, FIGS. 1 to 4 depict the preferred embodiment of the 360 degree image collecting apparatus 100. The 360 degree image collecting apparatus 100 comprises a model platform 110, a rotate platform 120, and a camera 130. The model platform 110 comprises a base board 112 rested on the ground, and a stand board 111 fixed over the base board 112. Preferably both the stand board 111 and the base board 112 are in round shape. A model 500 can stand on the stand board 111.

The rotate platform 120 is in a round shape, and is rotatablely rested over the base board 112. The rotation axis coincides with the center of the stand board 111. The diameter of the rotate platform 120 is larger than the diameter of the stand board 111.

The rotate platform 120 comprises a camera frame 121. The camera frame 121 is in an L shape and comprises a horizontal arm 122 extended radically from the rotate board 120, and a vertical arm 123 stands at the end of the horizontal arm 122. The camera 130 and other accessories such as lightings are attached on the vertical arm 123. The horizontal arm 122 provides a predetermined focal length for the camera 130 to have enough field size for taking the whole body of the model 500 in the picture without using a wide-angle lens which will cause image deformation. The height of the camera 130 on the vertical arm 123 is adjustable according to the height of the model 500.

The rotate platform 120 comprises a background screen 124 standing on the edge of the rotate board 120 at the opposite side of the camera frame 121. The background screen 124 and the camera frame 121 will be rotated with the rotate platform 120. The background screen 124 always covers the screen field of the camera 130 therefore objects behind the model 500 will not be taken into the picture. In the preferred embodiment, the background screen 124 comprises 5 bars 125 to support the screen 124. And the rotate platform 120 also comprises 5 holders 126 to hold the bars 125 to stand vertically at the edge of the rotate platform 120. Both the camera frame 21 and the background screen 124 are removable to save space.

When a model 500 is standing on the center of the stand board 111, the rotate platform 120 can carry the camera 130 and the background screen 124 to rotate around the model 500. In this way the camera 130 can take a set of pictures at different angle of the model 500. Preferably, the camera will take a picture when the rotate platform rotates a particular angle. For example the camera 130 can take a picture very 5 degree, then after rotating 360 degree, the camera 130 will take 72 pictures as one set. Using these 72 pictures a 3D effect image can be created showing 360 degree image of the model 500. With current techniques, one set of pictures can be taken in less than 15 seconds.

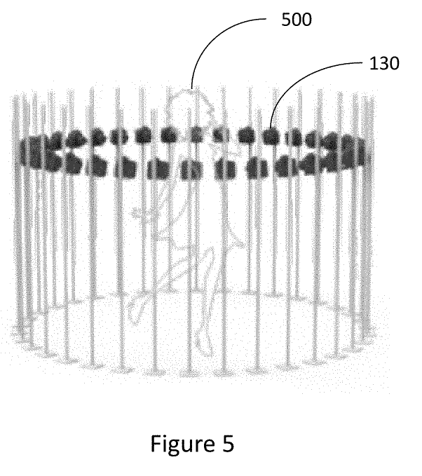

Referring to FIG. 5, in an alternative embodiment, the 360 degree image collecting apparatus 100 comprises multiple cameras 130 fixed on the ground to form a circle. The model 500 will stand at the center of the circle. All cameras 130 will take a picture from different angle at the same time. Therefore it will take less than 1 second to collect one set of pictures for 360 degree image of the model 500. For example, in an embodiment of the invention, the 360 degree image collecting apparatus 100 comprises 36 cameras 130 separated by 10 degree. Therefore each time 36 pictures will be taken to form one set of pictures.

In another alternative embodiment, the 360 degree image collecting apparatus 100 could be a portable device with a camera, such as a smart phone, a regular camera, or a tablet. It can be operated by hand to take a set of pictures around the model in 360 degree.

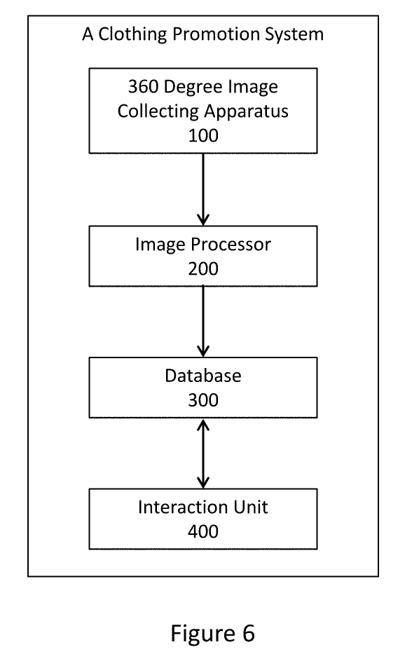

Referring to FIG. 6, in an preferred embodiment, a clothing promotion system comprises a 360 degree image collecting apparatus 100 to collect image date; an image processor 200 to process the image data collected by the 360 degree image collecting apparatus 100 and to generate 3D effect images; a database 300 to store the data and images; and a plurality of interaction units 400 to interact with the image processor 200 and to display the 3D effect images.

First, the 360 degree image collecting apparatus 100 takes a set of pictures for each model. It is worth mentioning, the model 500 could be a consumer; a hired professional model; or a dummy. By analyzing the image data collected from one set of pictures of one model 500 taking by the 360 degree image collecting apparatus 100, the image processor 200 generates a set of parameters of the model 500, including face image, height, body shape, size, etc. These parameters can describe the model's body figures. This set of parameters is then associated with other information of the model 500 and is stored in the database 300. For example, if the model 500 is a consumer, then his/her personal profile, account information, personal preferences, etc. are also stored with all the image data and the set of parameters in the database 300. The image processor 200 also generates a 3D component of the model's head using the image data of the model. The 3D component of the head can be displayed to illustrate the 3D effect image of the model's head.

Then, the 360 degree image collecting apparatus 100 takes a set of pictures for each clothing article worn by each applicable model respectively. The clothing article could be one piece of clothes, such as a shirt, a coat, a skirt, pants, etc.; or a pair of shoes; or a piece of ornaments such as a necklace. It is worth mentioning, same design with different sizes, colors, or materials are considered to be different clothing articles. Also, different models wearing the same clothing article are considered as different scenarios and need to take different sets of pictures because the effects could be different. The applicable model could be a dummy or a professional model hired by the seller or manufacturer of the clothing article. The dummies and the professional models could have different sizes and shapes to illustrate different effects which is called different scenarios. The applicable model could also be a consumer who is able to wear this clothing article.

If a design, for example a shirt, has 4 sizes, 3 colors, 2 materials, this design will have 4×3×2=24 clothing articles. If there are 1 professional model, 2 dummies, 5 consumers are applicable to wear each clothing article, then there will be 1+2+5=8 scenarios for each clothing article. Theoretically, totally 24×8=192 sets of pictures could be taken to illustrate 192 scenarios of the design of the shirt. In reality, usually one professional model or one dummy may only wear one size of the design. One consumer may wear only one article of the design.

By analyzing the image data collected from one set of pictures for one scenario of the clothing article, the image processor 200 generates a 3D component and a set of parameters to describe the related body figures of the model who wearing the clothing article. The 3D component and the set of parameters are associated and stored in the database. The 3D component can be displayed individually to illustrate the 3D effect of the scenario. The image processor 200 also combines different 3D components to create a 3D effect image. The 3D effect image illustrates a 3D effect of a whole body or a portion of a body wearing one or more clothing articles.

For example, a 3D effect image is combined with a 3D component of a first consumer's head; a 3D component of a shirt worn by a model; a 3D component of a skirt worn by a second consumer; and a 3D component of a pair of shoes worn by a dummy. This 3D effect image can simulate an effect of the first consumer wearing the shirt, the skirt, and the shoes. The created 3D effect image is stored in the database 300.

The interaction unit 400 is an input/output device for the users. The interaction unit 400 displays the 3D effect images created by the image processor 200. The interaction unit 400 also inputs data and commands to the system by the user. The interaction unit 400 also comprises a camera. The camera is used to be an alternative image collecting devices to collect image data such as the user's face and body figures. This image data is used by the image processor 200 to create 3D component of the user's head, and parameters for body figures. The interaction unit 400 could be but not limited to PC, smart phone, tablet, etc. The interaction unit 400 is communicatively connected with the database 300 of the system to acquire the data of the image, preferably through internet.

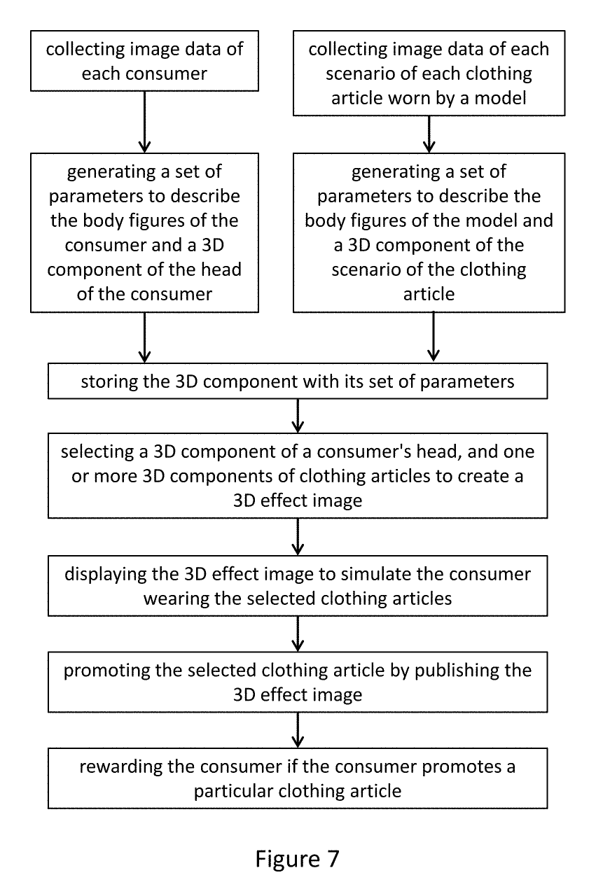

FIG. 7 illustrates a method to promote clothing using the clothing promotion system. In a preferred embodiment, the clothing promotion system collects personal information of each user. First the 360 degree image collecting apparatus 100 takes a set of pictures of the user; then the image processor 200 analyzes the image data of the set of pictures and generates a set of parameters of the user, including but not limited to face image, height, body shape, size, etc. to describe the user's body figures. The image processor 200 also generates a 3D component of the user's head. The 3D component of the head can be displayed to illustrate the 3D effect image of the model's head. The clothing promotion system may also ask the user to create an account, collect user's profile and preferences through the interaction unit 400, and stores all this personal information under the user's account.

In an alternative embodiment, the image data can be collected by the camera of the interaction unit 400.

The clothing promotion system also collects clothing information of each clothing article. First, the 360 degree image collecting apparatus 100 takes a set of pictures for each clothing article worn by each applicable model respectively. The clothing article could be one piece of clothes promoted by the seller or the manufacturer; it also could be a piece of clothes owned by a consumer.

Also, different models can wear the same clothing article to take different sets of pictures to represent different scenarios. The applicable model could be a dummy or a professional model hired by the seller or manufacturer of the clothing article for promotion. The dummies and the professional models could have different sizes and shapes to illustrate different effect which is called different scenario. The applicable model could also be a consumer who is willing to participate in the clothing promotion.

By analyzing the image data collected from these sets of pictures, the image processor 200 generates a 3D component for each scenario of each clothing article and store it in the database 300 associated with the parameters describing the related body figures of the model.

Then by using the interaction unit 400, the user of the clothing promotion system selects the preferred 3D components to create a 3D effect image. This 3D effect image is able to be displayed by a interaction unit 400, it is also able to be published in the system of the current invention, or any other medium. The user could be a consumer; or a seller or manufacturer.

In a preferred embodiment, when the user is a consumer, he/she can use the interaction unit 400 to select the 3D component of his/her own head. Then he/she can select the 3D components of the clothing articles, and combine them together to create a complete 3D effect image. For example, when a female consumer is shopping a shirt promoted in the system, she can select the 3D component of the shirt she likes which is worn by a model. This model can be selected by the consumer by her visual judgment. Or, the system can recommend one or more models by comparing their parameters of body figures with the consumers. She can also input the data of the parameters if she is shopping for somebody else. The 3D component of the shirt can be created by the seller or manufacturer, or by other consumers.

Then she can select other 3D components to combine with this 3D component to form a complete 3D effect image. These 3D components could be created by herself which meanings these clothing articles were owned by herself and worn by herself when the sets of pictures were taken. In this way, the created 3D effect image can efficiently simulate the real effect, not only the effect of the shirt on her body, but the effect of pairing with her own clothes. She can easily try different collocations with her other 3D components of clothing articles using this system; of course, if she is not satisfied with the clothing articles she currently owns, she can also easily try collocations with clothing articles created by any other consumers, and any sellers or manufactures. If she is satisfied, she can make the order by the system of the present invention.

The consumer can also publish the 3D effect image in the system of the present invention, or on other social medium to collect comments, or to promote the clothing articles he/she selected. When the consumer is willing to participate in the clothing promotion, he/she can select preferred clothing articles to pair with each other and create a 3D image to illustrate the collocation, and then publish the image in the system or other social medium. The selection may not be restricted by the brand or manufacturer of the clothes. Since there are huge amount of possibilities of collocation, considering the different designs, sizes, colors, materials, model's body figures, etc., other consumer's recommendation may largely reduce the pairing time, and be more convincible.

When the user is a seller or manufacturer, he/she can hire professional models and dummies to wear his/her products (the clothing articles) to generate 3D components for the consumers to select. Of course he can select the 3D component of the clothing article he wants to promote, combined with a model or dummy's head, and with other clothing articles to create a 3D effect image to promote this clothing article. He can also encourage the consumers to publish the images selecting his/her products by rewarding them.

While the embodiments and alternatives of the invention have been shown and described, it will be apparent to one skilled in the art that various other changes and modifications can be made without departing from the spirit and scope of the invention.

What is claimed is:

1. A 360 degree image collecting apparatus generating 3D effect image for a model, comprising:
a camera taking pictures of said model;
a model platform comprising a base board rested on the ground; and a stand board fixed over said base board supporting said model to stand thereon; and
a rotate platform rotatablely rested over said base board and under said model platform, comprising a camera frame supporting said camera focusing on said model with an adjustable height and a predetermined focal length, wherein said rotate platform rotates said camera around said model over said stand board to take multiple pictures from different angles.

2. The 360 degree image collecting apparatus, as recited in claim 1, wherein said rotate platform comprises a background screen standing on said rotate board at the opposite side of said camera frame to cover the screen field of said camera.

3. The 360 degree image collecting apparatus, as recited in claim 2, wherein said camera takes a picture when said rotate platform rotates every predetermined degree for 360 degree.

4. The 360 degree image collecting apparatus, as recited in claim 3, wherein said camera frame and said background screen are detachable from said rotate platform.

5. A clothing promotion system, comprising:
a 360 degree image collecting apparatus collecting image data of a plurality of models' heads and a plurality of clothing articles worn by models, wherein said models could be consumers, professional models, or dummies;
an image processor processing said image data collected by said 360 degree image collecting apparatus and generating 3D components of said models' heads and said clothing articles wherein said 3D components can be displayed in 3D effect;
a database storing said image data and 3D components; and
a plurality of interaction units interacting with said image processor and said database to select 3D components of a model's head and one or more clothing articles to create a 3D effect image, and displaying said created 3D effect image to illustrate the effect of said selected model wearing said selected clothing articles.

6. The clothing promotion system, as recited in claim 5, wherein said 360 degree image collecting apparatus collects image data by taking a set of pictures around said model every predetermined degree for 360 degree.

7. The clothing promotion system, as recited in claim 6, wherein said image processor also generates a set of parameters to describe said model's body figures.

8. The clothing promotion system, as recited in claim 7, wherein said interaction unit recommends clothing articles worn by models having body figures preferred by the consumer.

9. The clothing promotion system, as recited in claim 8, wherein said interaction units comprises a display to illustrate any 3D effect images stored in said database.

10. The clothing promotion system, as recited in claim 9, wherein said interaction units are communicatively connected with internet to promote the clothing articles selected for creating said 3D effect images.

11. The clothing promotion system, as recited in claim 10, wherein said interaction units collects consumers' information to store in the database associated with their sets of parameters.

12. The clothing promotion system, as recited in claim 11, wherein said 360 degree image collecting apparatus is a portable device with a camera, wherein said 360 degree image collecting apparatus, said image processor, said database, and said interaction units and communicatively connected though internet.

13. A method of clothing promotion, comprising the steps of:
(a) collecting image data of each consumer;
(b) generating a set of parameters to describe the body figures of said consumer and a 3D component of the head of said consumer using said image data collected from said consumer;
(c) collecting image data of each scenario of each clothing article worn by a model, wherein said model could be a consumer, a professional model, or a dummy;
(d) generating a set of parameters to describe the body figures of said model and a 3D component of said scenario of said clothing article using said image data;
(e) storing said 3D component with its set of parameters;
(f) selecting a 3D component of a consumer's head, and one or more 3D components of clothing articles to create a 3D effect image; and
(g) displaying said 3D effect image to simulate said consumer wearing said selected clothing articles.

14. The method of clothing promotion, as recited in claim 13, wherein said image data is collected by taking a set of pictures around said model every predetermined degree for 360 degree.

15. The method of clothing promotion, as recited in claim 14, wherein in step (f), said 3D component of clothing article is selected according to a selected set of parameters of the body figures.

16. The method of clothing promotion, as recited in claim 15, wherein further comprises a step of:
(h) promoting said selected clothing article by publishing said 3D effect image created with said clothing article.

17. The method of clothing promotion, as recited in claim 16, wherein further comprises step of:
(i) rewarding the consumer if said consumer promotes a particular clothing article.

18. The method of clothing promotion, as recited in claim 17, wherein in step (e), when said model is a consumer, if said clothing article belongs to said consumer, said 3D component is associated with said consumer.

19. The method of clothing promotion, as recited in claim 18, wherein in step (f), said consumer can select said associated 3D components to create 3D effect image with other 3D components.

20. The method of clothing promotion, as recited in claim 17, wherein in step (c), when said model is a professional model or a dummy, said model is hired to wear said clothing article for promotion.

21. The method of clothing promotion, as recited in claim 20, wherein the 3D component of said clothing article for promotion is shared for the consumer to select to create 3D effect image.

22. The method of clothing promotion, as recited in claim 21, wherein said clothing article which is promoted is for sale.
